(19) United States
(12) Patent Application Publication
(10) Pub. No.: US 2015/0301679 A1
(43) Pub. Date: Oct. 22, 2015

(54) TOUCHSCREEN DEVICE AND TOUCH SENSING METHOD

(71) Applicant: SAMSUNG ELECTRO-MECHANICS CO., LTD., Suwon (KR)

(72) Inventors: Kang Joo KIM, Suwon (KR); Moon Suk Jeong, Suwon (KR)

(73) Assignee: SAMSUNG ELECTRO-MECHANICS CO., LTD., Suwon (KR)

(21) Appl. No.: 14/686,021

(22) Filed: Apr. 14, 2015

(30) Foreign Application Priority Data
Apr. 21, 2014 (KR) 10-2014-0047397

(51) Int. Cl. G06F 3/041; G06F 3/044

(52) U.S. Cl. CPC G06F 3/0416; G06F 3/044

(57) ABSTRACT

A touchscreen device may include a panel unit including a plurality of first electrodes and a plurality of second electrodes; a driving circuit unit sequentially applying a driving signal having a predetermined period to the plurality of first electrodes; a sensing circuit unit detecting levels of capacitance from the plurality of second electrodes; and a driving voltage generating unit generating a driving voltage. The driving voltage generating unit adjusts a level of the driving voltage depending on a detected voltage which is detected in a first electrode, to which the driving signal is applied, among the plurality of first electrodes in a calibration section.

### CROSS-REFERENCE TO RELATED APPLICATION

This application claims priority to, and the benefit of, Korean Patent Application No. 10-2014-0047397 filed on Apr. 21, 2014, with the Korean Intellectual Property Office, the disclosure of which is incorporated herein by reference.

### BACKGROUND

The present disclosure relates to a touchscreen device and a touch sensing method.

A touchscreen device, such as a touchscreen and a touch pad, which is a data input device attached to a display device to provide an intuitive input method to a user, has recently been widely used in various electronic devices, such as cellular phones, personal digital assistants (PDAs), and navigation devices. Particularly, as a demand for smartphones has recently increased, the use of touchscreens, as devices capable of providing users with various methods of data input in a limited form factor, has gradually increased.

Touchscreens used in portable devices may be mainly divided into resistive type touchscreens and capacitive type touchscreens, depending on touch sensing methods. In this regard, capacitive type touchscreens have advantages such as relatively long lifespans and ease in the implementation of various input methods and gestures, such that the use thereof has gradually increased. Particularly, multi-touch interfaces may be more easily implemented in capacitive type touchscreens, as compared with resistive type touchscreens, and thus, the capacitive type touchscreens are widely used in devices such as smartphones.

Such capacitive type touchscreens include a plurality of electrodes having a predetermined pattern, and a plurality of nodes in which changes in capacitance are generated by a touch are defined by the plurality of electrodes. In the plurality of nodes distributed on a two-dimensional plane, changes in self-capacitance or mutual-capacitance are generated by touches. Coordinates of such a touch may be calculated by applying a weighted average calculating method, or the like, to the changes in capacitance generated in the plurality of nodes.

A controller integrated circuit, which applies a driving signal to a touchscreen panel and detects changes in capacitance to determine whether a touch has occurred, does not use input power provided from an external power source, but may use a low-dropout (LDO) voltage output from an LDO regulator as a driving voltage in order to prevent an integrated circuit (IC) from being damaged due to an unexpected voltage fluctuation, or the like.

However, even in a case of using the output voltage of the LDO regulator, a phenomenon in which a level of the output voltage overshoots a level of a target voltage during initial operations of the LDO regulator may occur. In addition, even in a case in which a stabilized output voltage is provided by the LDO regulator as a driving voltage for each unit, respective impedances of electrodes may be slightly different from each other due to errors occurring in the process of manufacturing the plurality of electrodes. Therefore, different levels of capacitance may be formed between the electrodes.

### RELATED ART DOCUMENT

(Patent Document 1) Korean Patent Laid-Open Publication No. 2013-062189

### SUMMARY

An exemplary embodiment in the present disclosure may provide a touchscreen device and a touch sensing method capable of adjusting a driving voltage depending on a voltage detected in an electrode to which a driving signal is applied.

According to an exemplary embodiment in the present disclosure, a touchscreen device may include: a panel unit including a plurality of first electrodes and a plurality of second electrodes; a driving circuit unit sequentially applying a driving signal having a predetermined period to the plurality of first electrodes; a sensing circuit unit detecting levels of capacitance from the plurality of second electrodes; and a driving voltage generating unit generating a driving voltage, wherein the driving voltage generating unit adjusts a level of the driving voltage depending on a detected voltage which is detected in a first electrode, to which the driving signal is applied, among the plurality of first electrodes in a calibration section.

The sensing circuit unit may detect the levels of capacitance from the plurality of second electrodes after the calibration section ends.

The driving voltage generating unit may maintain the driving voltage set at the end of the calibration section until the next calibration section starts.

The driving voltage generating unit may include: a detecting unit detecting the detected voltage; a driving voltage adjusting unit adjusting a set voltage depending on the detected voltage; and a low-dropout (LDO) regulator generating the driving voltage depending on the set voltage.

The driving voltage generating unit may further include a boosting unit boosting the driving voltage generated by the LDO regulator.

The boosting unit may include a charge pump circuit.

The detecting unit may include a plurality of detectors disposed between each of the plurality of first electrodes and a ground, each of the plurality of detectors including a resistor element and a switching element connected to each other in series.

The switching element connected to the first electrode, to which the driving signal is applied, among the plurality of first electrodes may perform a switching-on operation in the calibration section.

The driving voltage adjusting unit may include: a comparing unit comparing the detected voltage and a predetermined reference voltage with each other; and a driving voltage setting unit adjusting the set voltage depending on a comparison result of the comparing unit.

The comparing unit may output the comparison result once per period of the driving signal.

The comparing unit may include: a first operational amplifier comparing the detected voltage and a first reference voltage with each other; and a second operational amplifier comparing the detected voltage and a second reference voltage with each other.

The detected voltage may be applied to non-inverting terminals of the first and second operational amplifiers, the first and second reference voltages may be applied to inverting terminals of the first and second operational amplifiers, respectively, and the first reference voltage may be higher than the second reference voltage.

The driving voltage setting unit may adjust the set voltage depending on the comparison result according to a preset period.

The driving voltage setting unit may raise or lower a level of the set voltage by a preset level in a stepwise manner, depending on the comparison result.

The set voltage which is set at the time of an initial operation of the driving voltage setting unit may be lower than a target level of the driving voltage.

The touchscreen device may further include a signal converting unit converting the level of capacitance into a digital signal.

A touch may be determined from the digital signal output from the signal converting unit.

According to another exemplary embodiment in the present disclosure, a touch sensing method may include: generating a driving voltage; applying a driving signal having a predetermined period to a plurality of first electrodes; adjusting the driving voltage depending on a detected voltage which is detected in a first electrode, to which the driving signal is applied, among the plurality of first electrodes; and detecting levels of capacitance from a plurality of second electrodes intersecting with the first electrode to which the driving signal is applied.

The levels of capacitance may be detected after the driving voltage is adjusted.

The adjusting of the driving voltage may include: detecting the detected voltage; comparing the detected voltage and at least one reference voltage with each other; adjusting a set voltage depending on a comparison result between the detected voltage and the reference voltage; and changing the driving voltage depending on the set voltage.

The detected voltage may be detected from a resistor element connected to the first electrode to which the driving signal is applied, among a plurality of resistor elements connected to the plurality of first electrodes, respectively.

The reference voltage may include first and second reference voltages that are preset, and each of the first and second reference voltages may be compared with the detected voltage.

The comparison result between the detected voltage and the reference voltage may be output once per period of the driving signal.

The set voltage may be adjusted depending on the comparison result according to a preset period.

A level of the set voltage may be raised or lowered by a preset level in a stepwise manner, depending on the comparison result.

The set voltage which is set at the time of initial adjustment of the driving voltage may be lower than a target level of the driving voltage.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view illustrating an exterior appearance of an electronic device including a touchscreen device according to an exemplary embodiment in the present disclosure;

FIG. 2 is a view illustrating a panel unit included in the touchscreen device according to the exemplary embodiment in the present disclosure;

FIG. 3 is a cross-sectional view of the panel unit included in the touchscreen device according to the exemplary embodiment in the present disclosure;

FIG. 4 is a view illustrating the touchscreen device according to the exemplary embodiment in the present disclosure;

FIG. 5 is a block diagram illustrating a driving voltage generating unit according to the exemplary embodiment in the present disclosure;

FIG. 6 is a view illustrating a detecting unit according to the exemplary embodiment in the present disclosure;

FIG. 7 is a block diagram illustrating a driving voltage adjusting unit according to the exemplary embodiment in the present disclosure;

FIG. 8 is a circuit diagram illustrating a comparing unit according to the exemplary embodiment in the present disclosure; and

FIG. 9 is a view illustrating respective operation sections of components in the touchscreen device according to the exemplary embodiment in the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

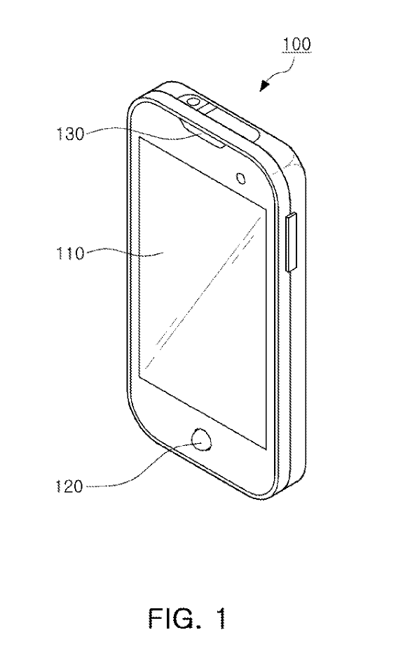

FIG. 1 is a perspective view illustrating an exterior appearance of an electronic device including a touchscreen device according to an exemplary embodiment in the present disclosure.

Referring to FIG. 1, an electronic device 100 according to the present exemplary embodiment may include a display device 110 for displaying images, an input unit 120, an audio unit 130 for audio output, and a touch sensing device integrated with the display device 110.

As illustrated in FIG. 1, in a case of a mobile device, the touch sensing device is generally provided to be integrated with the display device, and is required to have a degree of light transmissivity enough to allow an image displayed on the display device to be transmitted therethrough. Therefore, the touch sensing device may be obtained by forming electrodes using a transparent and electrically conductive material such as indium tin oxide (ITO), indium zinc oxide (IZO), zinc oxide (ZnO), carbon nano tube (CNT), or graphene, on a base substrate formed of a transparent film material such as polyethylene terephthalate (PET), polycarbonate (PC), polyethersulfone (PES), polyimide (PI), or polymethylmethacrylate (PMMA). In addition, the electrodes may be formed of a conductor wire formed of any one selected from the group consisting of Ag, Al, Cr, Ni, Mo, and Cu and alloys thereof.

The display device may include a wiring pattern disposed in a bezel region thereof, wherein the wiring pattern is connected to the electrode. Since the wiring pattern is visually blocked by the bezel region, they may also be formed of a metal such as silver (Ag) or copper (Cu).

When it is assumed that the touchscreen device according to the exemplary embodiment in the present disclosure is operated in a capacitive scheme, the touchscreen device may include a plurality of electrodes having a predetermined pattern. In addition, the touchscreen device may include a capacitance sensing circuit detecting changes in capacitance generated in the plurality of electrodes, an analog-to-digital converting circuit converting an output signal of the capacitance sensing circuit into a digital value, a calculating circuit determining a touch by using data converted into the digital value, and the like.

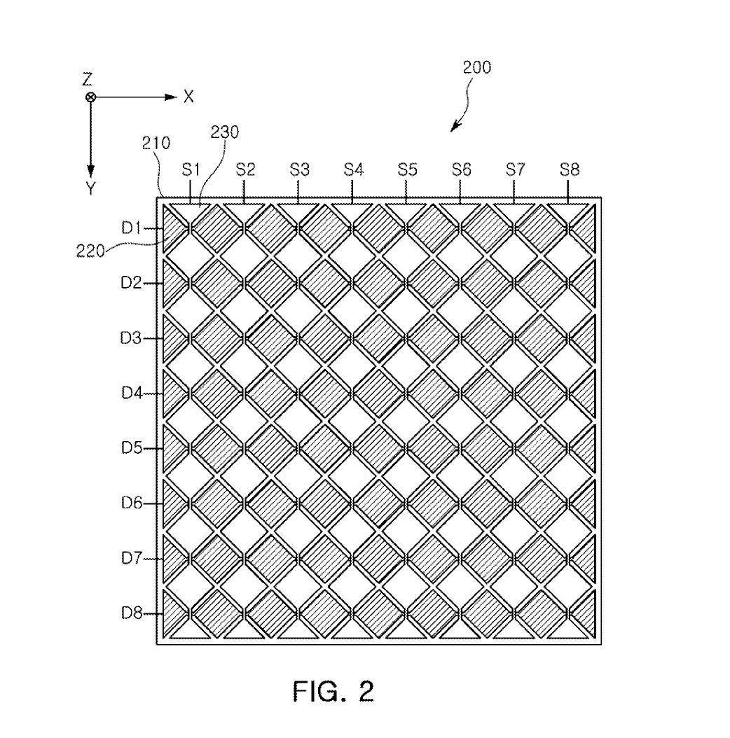

FIG. 2 is a view illustrating a panel unit included in the touchscreen device according to the exemplary embodiment in the present disclosure.

Referring to FIG. 2, a panel unit 200 according to the present exemplary embodiment may include a substrate 210 and a plurality of electrodes 220 and 230 formed on the substrate 210. Although not illustrated in FIG. 2, the plurality of electrodes 220 and 230 may be electrically connected to a wiring pattern of a circuit board attached to one end of the substrate 210 through wirings and bonding pads. Here, a controller integrated circuit (controlling unit) may be mounted on the circuit board to detect a detection signal generated in the plurality of electrodes 220 and 230 and determine a touch through the detection signal.

The plurality of electrodes 220 and 230 may be formed on one surface or both surfaces of the substrate 210. Although the plurality of electrodes 220 and 230 having a rhombic or diamond pattern are illustrated in FIG. 2, they may have various polygonal patterns such as a rectangular pattern or a triangular pattern.

The plurality of electrodes 220 and 230 may include first electrodes 220 extended in an X axis direction and second electrodes 230 extended in a Y axis direction. The first electrodes 220 and the second electrodes 230 may be formed to intersect with each other on both surfaces of the substrate 210, respectively, or be formed on different substrates 210, respectively. In a case in which both of the first electrodes 220 and the second electrodes 230 are formed on one surface of the substrate 210, insulating layers may be partially formed at intersection points between the first electrodes 220 and the second electrodes 230.

In addition, a predetermined printed region for visually blocking the wirings generally formed of an opaque metal may be provided in a region of the substrate 210 in which the wirings connected to the plurality of electrodes 220 and 230 are formed except for a region thereof in which the plurality of electrodes 220 and 230 are formed.

A touchscreen device electrically connected to the plurality of electrodes 220 and 230 to sense a touch may detect changes in capacitance generated in the plurality of electrodes 220 and 230 by the touch and sense the touch from the detected capacitance changes. The first electrodes 220 may be connected to channels defined as D1 to D8 in the controller integrated circuit to thereby receive a predetermined driving signal applied thereto, and the second electrodes 230 may be connected to channels defined as S1 to S8 to thereby be used for a touch sensing device to detect a detection signal. Here, the controller integrated circuit may detect a change in mutual-capacitance generated between the first and second electrodes 220 and 230 as the detection signal.

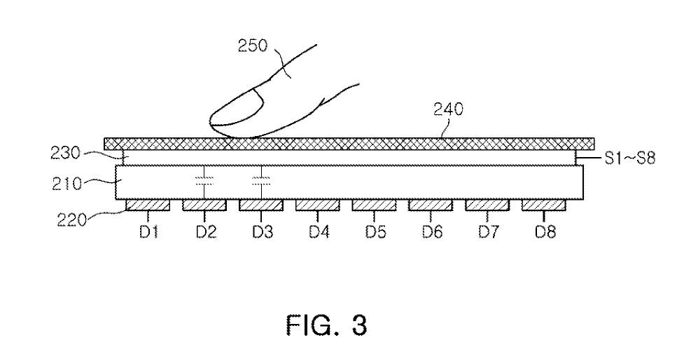

FIG. 3 is a cross-sectional view of the panel unit included in the touchscreen device according to the exemplary embodiment in the present disclosure. FIG. 3 is a cross-sectional view of the panel unit 200 illustrated in FIG. 2, taken along a Y-Z plane. The panel unit 200 illustrated in FIG. 3 may further include a cover lens 240 to which a touch is applied, in addition to the substrate 210 and the plurality of electrodes 220 and 230 as described above with reference to FIG. 2. The cover lens 240 may be provided on the second electrodes 230 for detecting the detection signal and may receive the touch applied by a touch object 250 such as a finger.

When the driving signal is applied to the first electrodes 320 through the channels D1 to D8, the mutual-capacitance may be generated between the first electrode 220 to which the driving signal is applied and the corresponding second electrode 230. When the touch object 250 touches the cover lens 240, there is a change in the mutual capacitance generated between the first and second electrodes 220 and 230 adjacent to a region touched by the touch object 250. The changes in capacitance may be in proportion to an area of the touch object 250. In FIG. 3, mutual-capacitance generated between the first electrode 220 and the second electrode 230 connected to the channels D2 and D3, respectively, may be affected by the touch object 250.

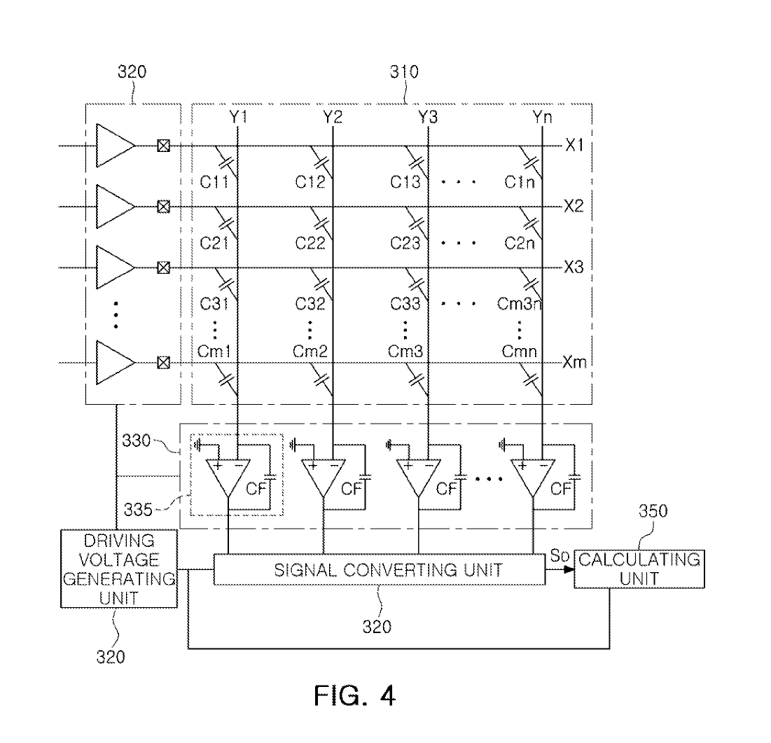

FIG. 4 is a view illustrating the touchscreen device according to the exemplary embodiment in the present disclosure.

Referring to FIG. 4, the touchscreen device according to the present exemplary embodiment may include a panel unit 310, a driving circuit unit 320, a sensing circuit unit 330, a signal converting unit 340, a calculating unit 350, and a driving voltage generating unit 360. Here, the driving circuit unit 320, the sensing circuit unit 330, the signal converting unit 340, and the calculating unit 350 may be configured as a single integrated circuit (IC).

The panel unit 310 may include a plurality of first electrodes X1 to Xm (driving electrodes) extended in a first axis direction (that is, a horizontal direction of FIG. 4) and a plurality of second electrodes Y1 to Yn extended in a second axis direction (that is, a vertical direction of FIG. 4). As described above, levels of capacitance may be generated at intersection points between the plurality of first electrodes X1 to Xm and the plurality of second electrodes Y1 to Yn, and node capacitors C11 to Cmn illustrated in FIG. 4 are used to illustrate the levels of capacitance generated at the intersection points between the plurality of first electrodes X1 to Xm and the plurality of second electrodes Y1 to Yn as capacitor components.

The driving circuit unit 320 may apply a predetermined driving signal to the plurality of first electrodes X1 to Xm of the panel unit 310. The driving signal may be a square wave signal, a sine wave signal, a triangle wave signal, or the like, having a predetermined period and amplitude and be sequentially applied to the plurality of first electrodes X1 to Xm. Although a case in which circuits for generating and applying the driving signal are individually connected to the plurality of first electrodes X1 to Xm, respectively, has been illustrated in FIG. 4, a single driving signal generating circuit may generate a driving signal and apply the generated driving signal to the plurality of first electrodes X1 to Xm, using a switching circuit. In addition, the driving circuit unit 320 may be operated in a scheme of simultaneously applying the driving signal to all of the first electrodes or selectively applying the driving signal to some of the first electrodes to simply sense whether or not the touch is present.

The sensing circuit unit 330 may detect levels of capacitance of the node capacitors C11 to Cmn from the plurality of second electrodes Y1 to Yn. The sensing circuit unit 330 may include a plurality of C-V converters 335, each of which includes at least one operational amplifier and at least one capacitor, wherein the plurality of C-V converters 335 may be connected to the plurality of second electrodes Y1 to Yn, respectively.

The C-V converter 335 may convert the level of capacitance of the node capacitor into a voltage signal to output an analog signal. For example, each C-V converter 335 may include an integration circuit for integrating capacitance. The integration circuit may integrate the capacitance to convert the capacitance into a predetermined voltage and output the converted voltage.

Although a case in which the C-V converter 335 is configured so that the capacitor CF is disposed between an inverting terminal and an output terminal of the operational amplifier has been illustrated in FIG. 4, a circuit configuration may be changed. In addition, although a case in which the C-V converter includes a single operational amplifier and a single capacitor has been illustrated in FIG. 4, the C-V converter may include a plurality of operational amplifiers and a plurality of capacitors.

In a case in which the driving signal is sequentially applied to the plurality of first electrodes X1 to Xm, levels of capacitance may be simultaneously detected from the plurality of second electrodes. Therefore, the number of C-V converters 335 may be n, the number of second electrodes Y1 to Yn.

The signal converting unit 340 may generate a digital signal S_{D} from the analog signal output from the sensing circuit unit 330. For example, the signal converting unit 340 may include a time-to-digital converter (TDC) circuit measuring a time taken for the analog signal output in a voltage form by the sensing circuit unit 330 to reach a predetermined reference voltage level and converting the measured time into the digital signal S_{D} or an analog-to-digital converter (ADC) circuit measuring an amount by which a level of the analog signal output from the sensing circuit unit 330 is changed for a predetermined time and converting the measured amount into the digital signal S_{D}.

The calculating unit 350 may determine a touch applied to the panel unit 310 using the digital signal S_{D}. The calculating unit 340 may determine the number, coordinates, gestures, or the like, of touches applied to the panel unit 310 using the digital signal S_{D}.

The digital signal S_{D}, which is used for the calculating unit 350 to determine a touch, may be data generated by digitizing changes in capacitance of the node capacitors C11 to Cmn, particularly, data indicating a difference between levels of capacitance in a case in which the touch does not occur and in a case in which the touch occurs. Generally, in a capacitive type touchscreen device, since the capacitance is decreased in a region that is touched by a conductive material as compared with a region that is not touched, a change in capacitance in the region that is touched by the conductive material may be larger than a change in capacitance in the region that is not touched.

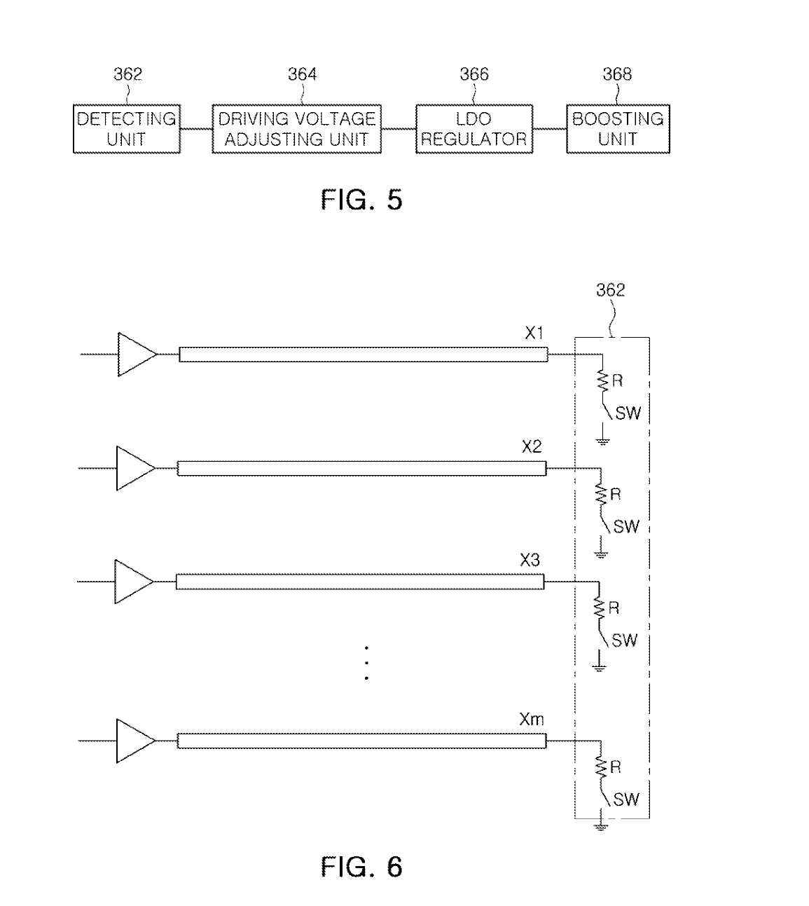

FIG. 5 is a block diagram illustrating a driving voltage generating unit according to the exemplary embodiment in the present disclosure. Referring to FIG. 5, the driving voltage generating unit 360 may include a detecting unit 362, a driving voltage adjusting unit 364, and a low-dropout (LDO) regulator 366, and may further include a boosting unit 368.

The LDO regulator 366 may regulate an input voltage transferred from the outside into a level of a set voltage determined by the driving voltage adjusting unit 364 and output the regulated voltage. The boosting unit 368 may boost the output voltage of the LDO regulator 366 and output the boosted voltage. According to an example, the boosting unit 368 may be configured as a charge pump circuit.

According to the present exemplary embodiment, the output voltage of the LDO regulator 366 or the output voltage of the boosting unit 368 may be supplied to the driving circuit unit 320, the sensing circuit unit 330, the signal converting unit 340, and the calculating unit 350. Hereinafter, both of terms “output voltage of LCO regulator” and “driving voltage” will be used together with each other for convenience of explanation.

FIG. 6 is a view illustrating a detecting unit according to the exemplary embodiment in the present disclosure. The detecting unit 362 may include a plurality of detectors, each of which may include a resistor element R and a switching element SW connected to each other in series.

In a case in which the driving circuit unit 320 is connected to one sides of the plurality of driving electrodes X1 to Xm, the detecting unit 362 may be disposed on the other sides of the plurality of driving electrodes X1 to Xm. In the detecting unit 362, the resistor elements R and the switching elements SW may be connected to each other in series and be disposed between the other sides of the plurality of driving electrodes X1 to Xm and a ground.

The switching elements SW may perform switching-on/off operations. In detail, the switching elements SW may perform the switching-on operation in a calibration section for calibrating the output voltage of the LDO regulator 366, and may perform the switching-off operation in sections other than the calibration section.

In a case in which the driving signal is applied to the plurality of driving electrodes X1 to Xm in the calibration section, the switching elements SW may perform the switching-on operation, such that a voltage may be detected depending on a resistance value of the resistor element R, and the detected voltage may be transferred to the driving voltage adjusting unit 364.

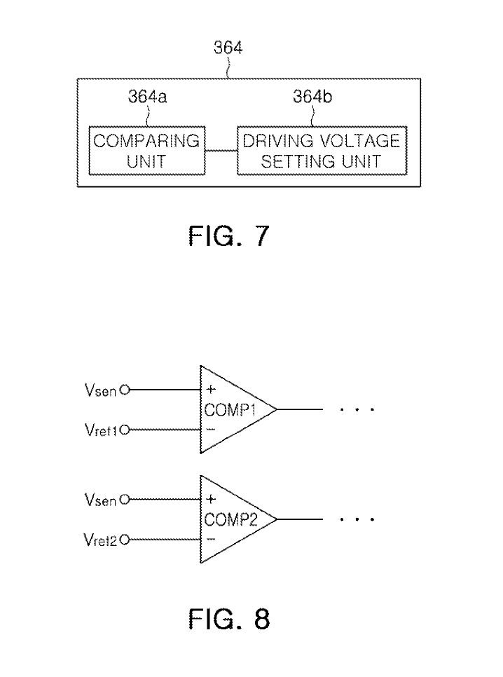

FIG. 7 is a block diagram illustrating a driving voltage adjusting unit according to the exemplary embodiment in the present disclosure. The driving voltage adjusting unit 364 may include a comparing unit 364a and a driving voltage setting unit 364b.

The comparing unit 364a may compare a predetermined reference voltage and the detected voltage transferred from the detecting unit 362 with each other, and may transmit a comparison result to the driving voltage setting unit 364b.

The driving circuit unit 320 may generate the driving signal varied in a preset voltage level range at a predetermined period. Therefore, a voltage level of the detected voltage Vsen of the detecting unit 362 may also be varied at a predetermined period. According to the exemplary embodiment, the comparing unit 364a may output the comparison result once per period of the driving signal in synchronization with the period of the driving signal in order to output an accurate comparison result. Therefore, the comparing unit 364a may compare a maximum level or a minimum level of the detected voltage with the predetermined reference voltage.

FIG. 8 is a circuit diagram illustrating a comparing unit according to the exemplary embodiment in the present disclosure. The comparing unit 364a may include at least two operational amplifiers COMP1 and COMP2, wherein a first operational amplifier COMP1 may compare a first reference voltage Vref1 and the detected voltage Vsen with each other and a second operational amplifier COMP2 may compare a second reference voltage Vref2 and the detected voltage Vsen with each other and output comparison results. Here, the first reference voltage Vref1 may be higher than the second reference voltage Vref2.

The first and second operational amplifiers COMP1 and COMP2 may have the detected voltage Vsen applied to non-inverting terminals thereof, and have the first and second reference voltages Vref1 and Vref2 each applied to inverting terminals thereof. In a case in which the detected voltage Vsen is higher than the first and second reference voltages Vref1 and Vref2, both of the first and second operational amplifiers COMP1 and COMP2 may output a high signal, in a case in which the detected voltage Vsen is between the first and second reference voltages Vref1 and Vref2, the first operational amplifier COMP1 may output a high signal and the second operational amplifier COMP2 may output a low signal, and in a case in which the detected voltage Vsen is lower than the first and second reference voltages Vref1 and Vref2, both of the first and second operational amplifiers COMP1 and COMP2 may output a low signal.

Again referring to FIG. 7, the driving voltage setting unit 364b may change a set voltage depending on the comparison result, wherein the set voltage may be used in order to determine a level of the output voltage of the LDO regulator 366.

The driving voltage setting unit 364b may change a level of the set voltage within a preset range. In detail, the driving voltage setting unit 364b may lower a level of the set voltage by one step in a case in which two high signals are transferred from the comparing unit 364a thereto, maintain a level of the set voltage in a case in which one low signal and one high signal are transferred from the comparing unit 364a thereto, and raise a level of the set voltage by one step in a case in which two low signals are output from the comparing unit 364a. Here, the step may mean a preset voltage level.

As described above, the comparing unit 364a may output the comparison result once per period of the driving signal. However, since a single period of the driving signal is very short, in a case in which the driving voltage setting unit 364b changes the level of the set voltage whenever the comparing unit 364a outputs the comparison result, the driving voltage is changed plural times for a short time, such that a reliable operation may not be secured. Therefore, according to the present exemplary embodiment, the driving voltage setting unit 364b may change the level of the set voltage depending on the comparison result of the comparing unit 364a at a preset period.

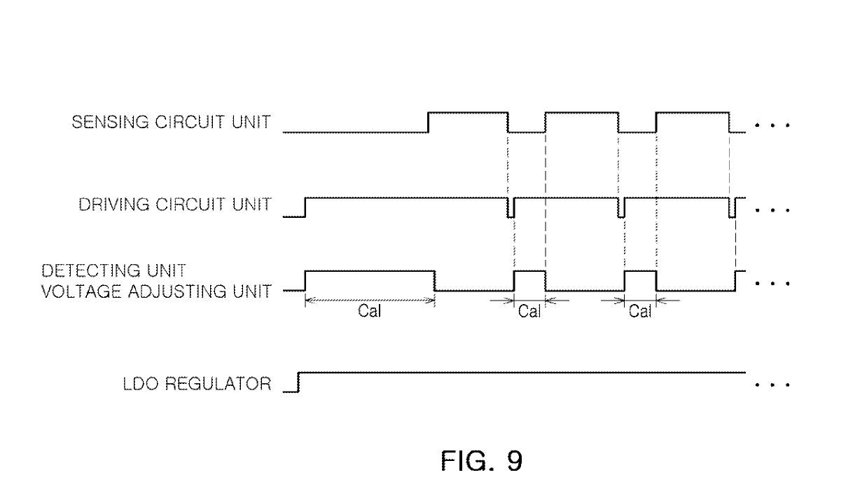

FIG. 9 is a view illustrating respective operation sections of components in the touchscreen device according to the exemplary embodiment in the present disclosure.

Referring to FIG. 9, when driving of the touchscreen device starts, the LDO regulator 366 may supply a driving voltage to each component of the touchscreen device. After the LDO regulator 366 starts to operate, the driving circuit unit 320 may start to operate. Then, the detecting unit 362 and the driving voltage adjusting unit 364 may start to operate. After the operations of the detecting unit 362 and the driving voltage adjusting unit 364 end, the sensing circuit unit 330 may start to operate.

The driving circuit unit 320 may sequentially apply a driving signal to the plurality of driving electrodes X1 to Xm, and a switching element of the detecting unit 362 connected to the driving electrode to which the driving signal is applied may perform a switching-on operation before the sensing circuit unit 330 is operated, whereby impedance errors in manufacturing the plurality of electrodes may be adjusted.

In more detail, the switching elements of the detecting unit 362 connected to the driving electrodes to which the driving signal is applied may perform the switching-on operation in the calibration section. Therefore, the detected voltage may be transferred to the comparing unit 364a, and the comparison result of the comparing unit 364a may be provided to the driving voltage setting unit 364b, such that the driving voltage setting unit 364b may change the set voltage. The LDO regulator 366 may generate the driving voltage depending on the set voltage, and maintain the driving voltage set at the end of a current calibration section until the next calibration section starts.

Since the set voltages adjusted in the calibration section may be set to be different from each other according to the driving electrodes by reflecting impedances of the driving electrodes to which the driving signal is applied, an impedance error between the plurality of driving electrodes may be adjusted.

A set voltage, set at the time of initial operating of the driving voltage setting unit 364b, may be lower than a target voltage, thereby preventing the output voltage of the LDO regulator 366 from overshooting the target voltage. Therefore, a calibration section of a driving electrode to which the driving signal is first applied may be set to be longer than those of the other driving electrodes.

As set forth above, according to the exemplary embodiments of the present disclosure, since the driving voltage may be set according to the driving electrodes by reflecting impedances detected in the driving electrodes to which the driving signal is applied, the impedance error between the plurality of driving electrodes may be adjusted, and a phenomenon that the driving voltage overshoots the target level may be prevented.

While exemplary embodiments have been shown and described above, it will be apparent to those skilled in the art that modifications and variations could be made without departing from the scope of the present invention as defined by the appended claims.

What is claimed is:

1. A touchscreen device comprising:
a panel unit including a plurality of first electrodes and a plurality of second electrodes;
a driving circuit unit sequentially applying a driving signal having a predetermined period to the plurality of first electrodes;
a sensing circuit unit detecting levels of capacitance from the plurality of second electrodes; and
a driving voltage generating unit generating a driving voltage,
wherein the driving voltage generating unit adjusts the driving voltage depending on a detected voltage which is detected from a first electrode, to which the driving signal is applied, among the plurality of first electrodes in a calibration section.

2. The touchscreen device of claim 1, wherein the sensing circuit unit detects the levels of capacitance from the plurality of second electrodes after the calibration section ends.

3. The touchscreen device of claim 1, wherein the driving voltage generating unit maintains the driving voltage set at the end of the calibration section until the next calibration section starts.

4. The touchscreen device of claim 1, wherein the driving voltage generating unit includes:
a detecting unit detecting the detected voltage;
a driving voltage adjusting unit adjusting a set voltage depending on the detected voltage; and
a low-dropout (LDO) regulator generating the driving voltage depending on the set voltage.

5. The touchscreen device of claim 4, wherein the driving voltage generating unit further includes a boosting unit boosting the driving voltage generated by the LDO regulator.

6. The touchscreen device of claim 5, wherein the boosting unit includes a charge pump circuit.

7. The touchscreen device of claim 4, wherein the detecting unit includes a plurality of detectors disposed between each of the plurality of first electrodes and a ground, each of the plurality of detectors including a resistor element and a switching element connected to each other in series.

8. The touchscreen device of claim 7, wherein the switching element connected to the first electrode, to which the driving signal is applied, among the plurality of first electrodes performs a switching-on operation in the calibration section.

9. The touchscreen device of claim 4, wherein the driving voltage adjusting unit includes:
a comparing unit comparing the detected voltage and a predetermined reference voltage with each other; and
a driving voltage setting unit adjusting the set voltage depending on a comparison result of the comparing unit.

10. The touchscreen device of claim 9, wherein the comparing unit outputs the comparison result once per period of the driving signal.

11. The touchscreen device of claim 10, wherein the comparing unit includes:
a first operational amplifier comparing the detected voltage and a first reference voltage with each other; and
a second operational amplifier comparing the detected voltage and a second reference voltage with each other.

12. The touchscreen device of claim 11, wherein the detected voltage is applied to non-inverting terminals of the first and second operational amplifiers,
the first and second reference voltages are applied to inverting terminals of the first and second operational amplifiers, respectively, and
the first reference voltage is higher than the second reference voltage.

13. The touchscreen device of claim 9, wherein the driving voltage setting unit adjusts the set voltage depending on the comparison result according to a preset period.

14. The touchscreen device of claim 9, wherein the driving voltage setting unit raises or lowers a level of the set voltage by a preset level in a stepwise manner, depending on the comparison result.

15. The touchscreen device of claim 9, wherein the set voltage which is set at the time of an initial operation of the driving voltage setting unit is lower than a target level of the driving voltage.

16. The touchscreen device of claim 1, further comprising a signal converting unit converting the level of capacitance into a digital signal.

17. The touchscreen device of claim 16, wherein a touch is determined from the digital signal output from the signal converting unit.

18. A touch sensing method, comprising:
generating a driving voltage;
applying a driving signal having a predetermined period to a plurality of first electrodes;
adjusting the driving voltage depending on a detected voltage which is detected in a first electrode to which the driving signal is applied among the plurality of first electrodes; and
detecting levels of capacitance from a plurality of second electrodes intersecting with the first electrode to which the driving signal is applied.

19. The touch sensing method of claim 18, wherein the levels of capacitance are detected after the driving voltage is adjusted.

20. The touch sensing method of claim 18, wherein the adjusting of the driving voltage includes:
detecting the detected voltage;
comparing the detected voltage and at least one reference voltage with each other;
adjusting a set voltage depending on a comparison result between the detected voltage and the reference voltage; and
changing the driving voltage depending on the set voltage.

21. The touch sensing method of claim 20, wherein the detected voltage is detected from a resistor element connected to the first electrode to which the driving signal is applied, among a plurality of resistor elements connected to the plurality of first electrodes, respectively.

22. The touch sensing method of claim 20, wherein the reference voltage includes first and second reference voltages that are preset, and
each of the first and second reference voltages is compared with the detected voltage.

23. The touch sensing method of claim 20, wherein the comparison result between the detected voltage and the reference voltage is output once per period of the driving signal.

24. The touch sensing method of claim 20, wherein the set voltage is adjusted depending on the comparison result according to a preset period.

25. The touch sensing method of claim 20, wherein a level of the set voltage is raised or lowered by a preset level in a stepwise manner, depending on the comparison result.

26. The touch sensing method of claim 20, wherein the set voltage which is set at the time of initial adjustment of the driving voltage is lower than a target level of the driving voltage.
